(19) United States
(12) Patent Application Publication
(10) Pub. No.: US 2008/0298886 A1
(43) Pub. Date: Dec. 4, 2008

(54) BICYCLE TUBE-CLAMP ASSEMBLY

(76) Inventor: Chao-Hu Chen, Taichung County (TW)

Correspondence Address: Chao-Hu Chen, 235 Chung - Ho, Box 8-24, Taipei, TW

(21) Appl. No.: 12/057,383

(22) Filed: Mar. 28, 2008

(30) Foreign Application Priority Data
May 28, 2007 (CN) 200720147478.2

(51) Int. Cl. F16B 7/04; B62J 39/00

(52) U.S. Cl. 403/373; 280/288.4

(57) ABSTRACT

A bicycle tube-clamp assembly comprises a body; the body including an upper tube portion and a lower tube portion; wherein the upper tube portion has a hollow structure and an interior of the upper tube portion having an upper inner annular surface; a part of the upper tube portion vertically to the upper surface is formed as an upper clamping portion which is slightly elastic; a lower tube portion is a hollow structure; an interior of the lower tube portion is formed as a lower inner annular surface; an end surface of the lower tube portion facing downwards is formed as a lower surface; a part of the lower tube portion vertically to the lower surface is formed as a lower clamping portion; and the lower clamping portion is slightly elastic; and a connection portion is between the upper tube portion and lower tube portion.

### FIELD OF THE INVENTION

The present invention relates to bicycles, and particularly to a bicycle tube-clamp assembly which is integrally formed. The tube assembly is formed by an upper tube portion for locking an cushion support tube and a lower tube portion for locking a seat tube. The locking operations of the upper tube portion and lower tube portion can be performed without any interaction.

### BACKGROUND OF THE INVENTION

Due to recent busy lifestyle, many people are lack of exercises, while they stay in offices very long time. Thus the health of these people is threatened. As a result, many people drive bicycles as exercise and thus they have the opportunity to have sunshine. This is especially suitable for city life because it is very difficult to find a parking space in city. As a result, many bicycle manufacturers try their best to improve the quality of bicycle to match the requirement of the bicycle drivers.

The endurance and comfort of a bicycle are based on the cushion support tube and the tube clamp of the seat tube which serves to adjust the height of the cushion of a bicycle so as to match the height of legs of the drivers. Adjustment of the tube clamp will adjust the height of the cushion and the force apply to the treadles. Once the clamping force of the tube clamp is insufficient to clamp the cushion support tube, it is possible that the cushion will slide as the bicycle runs, even the backbone of the drive will be hurt and thus the driver can not stand in the residue of the life.

One prior art design about the seat tube is disclosed. In that the seat tube has slits. A seat tube is installed with a clamping ring. The clamping ring has an opening. The clamping ring is formed with a transversal penetrating threaded hole for screwing a screw. The feature of the prior art is that a positioning sheet is provided. The positioning sheet is soft and can be received into the opening. One side of the positioning sheet is formed with a recess. An upper side and a lower side of the recess are installed with protruding sheets, respectively. The recess is arranged corresponding to a screw hole and a screw so that the screw can be screwed into the screw hole and thus the positioning sheet can be clamped in the opening and the slit and to be positioned therein. Then the clamping ring is positioned to the upper portion of the seat tube. A washer has an inner annular surface which is formed with an inner protruding block. Each block can be embedded into a respect slit to be positioned therein. The positioning sheet is positioned on the block.

The prior art structure installs the clamping tube upon the seat tube and a screw is used to tightly lock or release the ring of the clamping tube so as to have the effect of adjusting and fixing the cushion support tube. However the prior art structure is made of metal, while it is often that the bicycle is placed outwards. After a long time, it is possible to wear and become weak, the clamping tube will destroy and thus hurt the backbone of the driver. Moreover, the prior art clamping tube uses screws to tighten the seat tube, and the slits of the seat tube serve to retain the cushion support tube. Such retaining way is only by the clamping and compressing forces of the seat tube and cushion support tube, it is unsteady and the rusting of the metal will cause that the combining force between the seat tube and the cushion support tube weakens and thus the lifetime is shortened.

### SUMMARY OF THE INVENTION

Accordingly, the object of the present invention is to provide a bicycle tube-clamp assembly which can improve the defect in the prior art with a steady and firm structure.

To achieve above object, the present invention provides a bicycle tube-clamp assembly comprising a body; the body including an upper tube portion and a lower tube portion; wherein the upper tube portion has a hollow structure and an interior of the upper tube portion having an upper inner annular surface; and an upper side of the upper tube portion facing upwards is formed an upper surface; a part of the upper tube portion vertically to the upper surface is formed as an upper clamping portion which is slightly elastic; the upper clamping portion includes a first upper clamping end and a second upper clamping end facing toward the first upper clamping end, each of the first upper clamping end and second upper clamping end is formed with an upper clamping surface; an upper clamping channel is formed between the first upper clamping end and the second upper clamping end for providing a tightening margin as the upper clamping portion 21 is tightened. Each of the two upper clamping surface 214 has an upper tightening hole for positioning the upper clamping portion 21; each of the two lower clamping surfaces has a lower tightening hole for positioning the lower clamping portion. Each of the upper tightening holes is installed with a threaded metal upper ring for tightening the upper tightening unit; and the upper tube portion being formed with an upper annular groove; a lower tube portion is a hollow structure; an interior of the lower tube portion is formed as a lower inner annular surface; an end surface of the lower tube portion facing downwards is formed as a lower surface; a part of the lower tube portion vertically to the lower surface is formed as a lower clamping portion; and the lower clamping portion is slightly elastic; the lower clamping portion includes a first lower clamping end and a second lower clamping end facing toward the first lower clamping end; each of the first lower clamping end and second lower clamping end is formed with a lower clamping surface; a lower clamping channel is formed between the first lower clamping end and second lower clamping end for providing a tightening margin as the lower clamping portion is tightened; each of the first lower clamping end and second lower clamping end is formed with a threaded metal lower ring for tightening the lower tightening unit; a connection portion between the upper tube portion and lower tube portion, the connection portion is connected between the upper tube portion and lower tube portion.

The prior art structure is made of metal, which easy rust and thus is weakened. The present invention is made integrally by plastic injection molding. Before injection, upper rings and lower rings are embedded therein for tightly screwing the upper tightening unit and lower tightening unit to avoid that the body is destroyed due to compression. The prior art uses a clamping tube to lock a seat tube and the seat tube serves to fix a cushion support tube. Only one structure serves to lock the cushion support tube and seat tube, the locking force is weak. In the present invention, the upper tube portion serves to clamp the cushion support tube and the lower tube portion serves to clamp the seat tube. An upper tightening unit screws into the upper clamping portion so as to compress the upper clamping channel so as to clamp the cushion support tube. The lower tube portion serves to fix a seat tube of a bicycle. The lower tightening unit screws into a lower clamping portion so that the lower clamping channel is compressed to clamp the seat tube. The connection portion has a recessed portion, a first recess and a second recess, so that the upper tube portion and lower tube portion has no interaction. The operation of locking the cushion support tube to the upper tube portion and the operation of locking the seat tube to the lower tube portion can be performed individually.

The various objects and advantages of the present invention will be more readily understood from the following detailed description when read in conjunction with the appended drawing.

### BRIEF DESCRIPTION OF THE DRAWINGS

FIG. 1 is a schematic perspective view of the bicycle tube-clamp assembly of the present invention.

FIG. 2 is an exploded perspective view of the bicycle tube-clamp assembly of the present invention.

FIG. 3 is an assembled schematic view about the bicycle tube-clamp assembly of the present invention.

FIG. 4 is a lateral schematic view showing that the bicycle tube-clamp assembly of the present invention is assembled to a bicycle.

FIG. 5 is a schematic cross sectional view of the upper tube portion along a line AB of FIG. 3.

FIG. 6 is a schematic cross sectional view of the lower tube portion along a line CD of FIG. 3.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

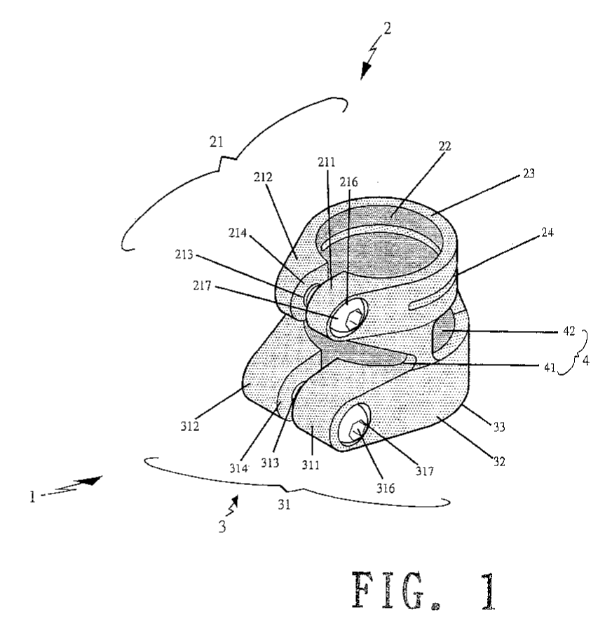

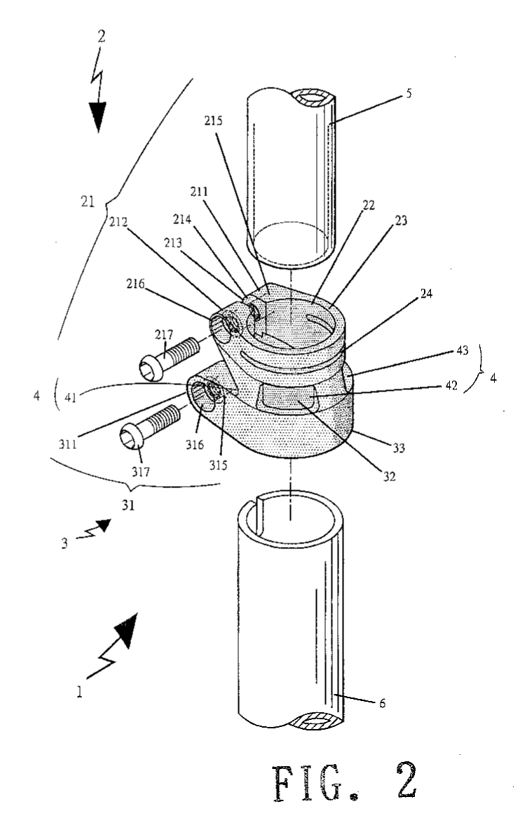

Referring to FIGS. 1 to 3, the structure of the present invention is illustrated. The body 1 of the present invention includes an upper tube portion 2 and a lower tube portion 3. An end surface of the upper tube portion 2 of the body 1 is assembled as an upper side and the end surface of the lower tube portion 3 of the body 1 is assumed as a lower side.

The upper tube portion 2 has a hollow annular U shape structure. The upper tube portion 2 is connected to a cushion support tube 6 of a seat cushion of a bicycle. An inner periphery of the upper tube portion 2 is formed as an inner annular surface 22. An upper surface of the upper tube portion 2 is formed as an upper surface 23 for installing the cushion support tube of a cushion. Further, the upper tube portion 2 includes an upper clamping portion 21 which is located at two ends of the U shape structure of the upper tube portion 2. The upper clamping portion 21 is an elastic structure by which the upper tube portion 2 can clamp the cushion support tube 5. The upper clamping portion 21 includes a first upper clamping end 211 and a second upper clamping end 212 at an position facing to the first upper clamping end 211. The surface of the first upper clamping end 211 facing toward the first upper clamping end 211 and the surface of the second upper clamping end 212 facing toward the second upper clamping end 212 are assembled as upper clamping surfaces 214. A space between the two upper clamping surfaces 214 is assembled as an upper clamping groove 213 for providing a tightening margin in tightly clamping the upper tube portion 2. Each of the first upper clamping end 211 and the second upper clamping end 212 is formed with upper tightening hole 216 for being screwed by an upper tightening unit 217 without damaging the body 1. Furthermore, an outer periphery of the upper tube portion 2 is formed with an upper annular groove 24 which has an approximate U shape. The formation of the upper annular groove 24 severs to reduce the weight of the body 1 and increase the elasticity of the upper tube portion 2.

The lower tube portion 3 is a hollow U shape structure. A structure of the lower tube portion 3 is approximately identical to that of the upper tube portion 2. The lower tube portion 3 is assembled to the seat tube 6 of a bicycle. An inner periphery of the lower tube portion 3 is formed as a lower inner annular surface 32. A surface of the lower tube portion 3 facing downwards is assumed as a lower surface 33 which is used for assembling the seat tube 6. Further, the lower tube portion 3 includes a lower clamping portion 31 which is positioned at two ends of the U shape structure of the lower tube portion 3 and is elastic for clamping the seat tube 6. The lower clamping portion 31 includes a first lower clamping end 311 and a second lower clamping end 312 corresponding to the first lower clamping end 311. A surface of the first lower clamping end 311 facing toward the second lower clamping end 312 and a surface of the second lower clamping end 312 facing toward the first lower clamping end 311 are assembled as lower clamping surfaces 314. A space between the two lower clamping surfaces 314 is formed as a lower clamping channel 313 for providing a tightening margin as the lower tube portion 3 is clamped tightly. Each of the first lower clamping end 311 and the second lower clamping end 312 is formed with a lower tightening hole 316 for being screwed by a respective lower tightening unit 317. Each of the lower clamping holes 316 of the first lower clamping end 311 and second lower clamping end 312 is installed with a lower ring 315 which is made of metal with inner thread therein. Thereby the lower tightening unit 317 threaded therein will not be destroyed.

A connection portion 4 is installed between the upper tube portion 2 and lower tube portion 3. The connection portion 4 is connected between the upper tube portion 2 and the lower tube portion 3. The connection portion 4 has a recessed portion 411, a first recess 42 and a second recess 43. The recessed portion 411 is recessed from an outer side of the body 1 so as to separate the upper tube portion 2 and the lower tube portion 3 to be as individual clamping structures. The functions of the first recess 42 and second recess 43 are identical to that of the recessed portion 411, that is, they are used to reduce the weight of the body 1.

The body 1 is formed by injection of plastics. Before plastic injection, it is embedded into the upper ring 215 and lower ring 315, because the body 1 is made of plastics, when the upper tightening unit 217 and lower tightening unit 317 are screwed to lock the upper clamping portion 21 and the lower clamping portion 31, respectively, the body 1 will be destroyed. The upper rings 215 and lower rings 315 have the effect of tightening the upper tightening unit 217 and lower tightening unit 317.

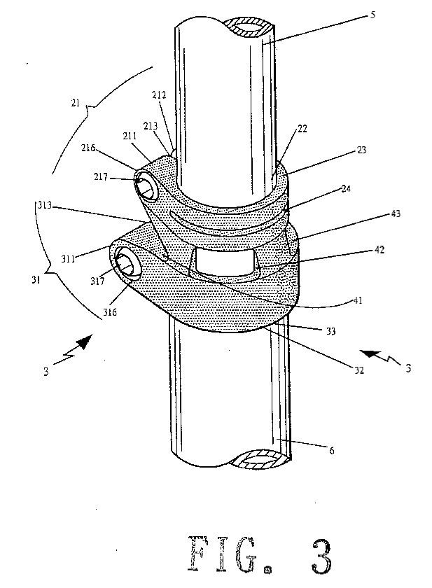

Referring to FIG. 3, the use of the present invention is illustrated. The cushion support tube 5 of a bicycle is installed in the upper tube portion 2 of the body 1. The upper tightening unit 217 of the upper clamping portion 21 will screw into the upper clamping hole so as to compress the upper clamping channel 213 to clamp the cushion support tube 5. The lower tube portion 3 of the body 1 serves to clamp the seat tube 6. The lower tightening unit 317 of the lower clamping portion 31 screws into the lower tightening holes 316 so as to compress the lower clamping channel 313. The recessed portion 411, first recess 42, and second recess 43 of the connection portion 4 will cause the upper tube portion 2 and lower tube portion 3 are not interacted. When the user locks one of the upper tube portion 2 and lower tube portion 3, another one will not act. Thereby the upper tube portion 2 can lock the cushion support tube 5 and the lower tube portion 3 can lock the seat tube 6 without any interaction.

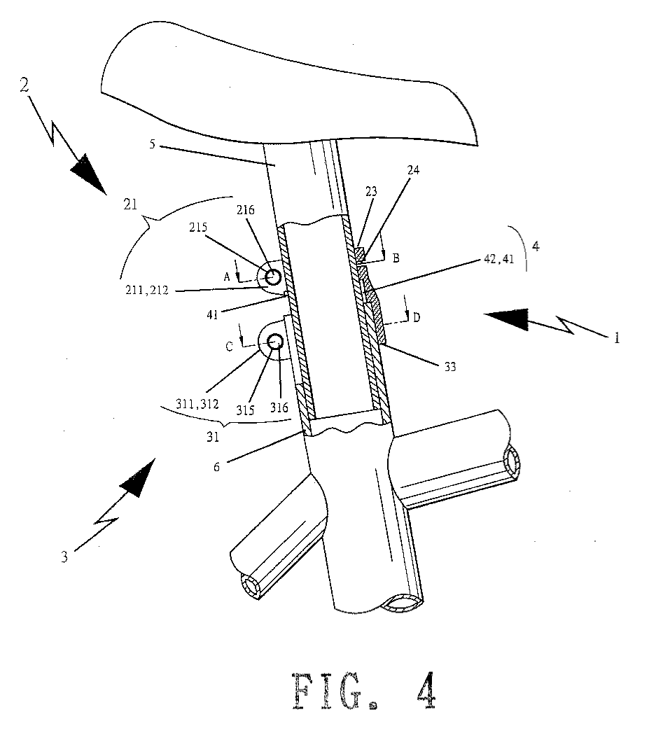

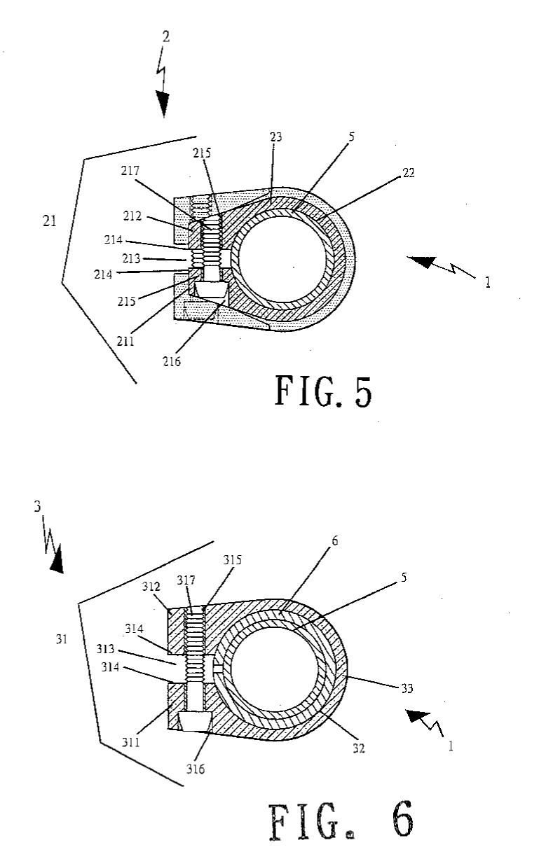

Referring to FIGS. 4 to 6, from FIG. 3, it is known that the cushion support tube 5 is engaged to the upper tube portion 2 and the seat tube 6 is engaged to the lower tube portion 3. In FIG. 4, it is illustrated that the upper tube portion 2 tightens the cushion support tube 5. In use, the cushion support tube 5 is engaged into the upper tube portion 2 from the upper surface 23. The upper tightening unit 217 will screw into the first upper clamping end 211, upper clamping channel 213, and second upper clamping end 212. Furthermore, the upper tightening unit 217 screws into the upper ring 215. Therefore, the upper clamping channel 213 is compressed. The upper ring 215 is made of metal which will not be destroyed due to the screwing operation of the upper tightening unit 217 of the body 1. Thus, the upper tube portion 2 will tighten the seat tube 6. FIG. 5 shows that the lower tube portion 3 tighten the seat tube 6. In use, the seat tube 6 enters into the lower tube portion 3 from the lower surface 33. The lower tightening unit 317 passes through the first lower clamping end 311, lower clamping channel 313, and second lower clamping end 312. Furthermore, the lower tightening unit 317 screws through the lower ring 315. Therefore, the lower clamping channel 313 is compressed. The lower ring 315 is made of metal to avoid that the lower tightening unit 317 is destroyed due to the screwing operation of the lower tightening unit 317. Thus, the lower inner annular surface 32 will clamp tightly the seat tube 6. Thus the lower tube portion 3 clamps the seat tube 6 tightly. Then the connection portion 4 causes the upper tube portion 2 and lower tube portion 3 not to interact. When one of the upper tube portion 2 and lower tube portion 3 is tightened, another one will not be interfered. Thus the upper tube portion 2 can tighten the cushion support tube 5 and the lower tube portion 3 can tighten the seat tube 6 individually.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A bicycle tube-clamp assembly comprising a body; the body including an upper tube portion and a lower tube portion; wherein the upper tube portion is a hollow structure; an interior of the upper tube portion having an upper inner annular surface; an upper side of the upper tube portion facing upwards is formed as an upper surface; and a part of the upper tube portion vertically to the upper surface is formed as an upper clamping portion which is slightly elastic;
a lower tube portion is a hollow structure; an interior of the lower tube portion is formed as a lower inner annular surface; an end surface of the lower tube portion facing downwards is formed as a lower surface; a part of the lower tube portion vertically to the lower surface is formed as a lower clamping portion; and the lower clamping portion is slightly elastic;
a connection portion between the upper tube portion and lower tube portion; the connection portion is connected between the upper tube portion and lower tube portion; and
when the upper clamping portion is tightened, the upper inner annular surface of the upper tube portion will be compressed by the upper clamping portion; and when the lower tube portion is tightened, the lower inner annular surface of the lower tube portion will be compressed by the lower clamping portion; and
wherein the upper surface of the upper tube portion serves to engage a cushion support tube and the lower surface of the lower tube portion serves to engage a seat tube, by tightening the upper inner annular surface of the upper tube portion and lower inner annular surface of the lower tube portion, the cushion support tube and seat tube will be tightened in the clamping tube.

2. The bicycle tube-clamp assembly as claimed in claim 1, wherein the upper tube portion, the connection portion and the lower tube portion are integrally formed.

3. The bicycle tube-clamp assembly as claimed in claim 2, wherein the upper tube portion, the connection portion and the lower tube portion of the body are made by plastic injection molding.

4. The bicycle tube-clamp assembly as claimed in claim 2, wherein in integrally forming process, a metal ring is embedded into the body; when the body is tightened, it will not be destroyed.

5. The bicycle tube-clamp assembly as claimed in claim 1, wherein the upper clamping portion includes a first upper clamping end and a second upper clamping end facing toward the first upper clamping end, each of the first upper clamping end and second upper clamping end is formed with an upper clamping surface; an upper clamping channel is formed between the first upper clamping end and the second upper clamping end for providing a tightening margin as the upper clamping portion is tightened.

6. The bicycle tube-clamp assembly as claimed in claim 1, wherein each of the two upper clamping surface has an upper tightening hole for positioning the upper clamping portion; each of the two lower clamping surfaces has a lower tightening hole for positioning the lower clamping portion.

7. The bicycle tube-clamp assembly as claimed in claim 6, wherein the upper tightening holes are received with an upper tightening unit for tightening the lower clamping portion and the lower tightening holes are received with a lower tightening unit for tightening the lower tube portion.

8. The bicycle tube-clamp assembly as claimed in claim 1, wherein the lower clamping portion includes a first lower clamping end and a second lower clamping end facing toward the first lower clamping end; each of the first lower clamping end and second lower clamping end is formed with a lower clamping surface; a lower clamping channel is formed between the first lower clamping end and second lower clamping end for providing a tightening margin as the lower clamping portion is tightened.

9. The bicycle tube-clamp assembly as claimed in claim 1, wherein the connection portion has a recessed portion which recesses inwards so as to cause that the tightening operations of the upper tube portion and lower tube portion can be performed individually.

10. The bicycle tube-clamp assembly as claimed in claim 9, wherein the connection portion is formed with a first recess and a second recess for reducing a weight of the connection portion so as to cause that the tightening operations of the upper tube portion and lower tube portion can be performed individually.
